(19) United States
(12) Patent Application Publication
(10) Pub. No.: US 2026/0291264 A1
(43) Pub. Date: Sep. 24, 2026

(54) BATTERY SYSTEM

(71) Applicant: Prime Planet Energy & Solutions, Inc., Tokyo (JP)

(72) Inventors: Yoshitomo NISHIHARA, Osaka-shi (JP); Tomonori KUNIMITSU, Himeji-shi (JP); Mikitaka TAMAI, Himeji-shi (JP)

(21) Appl. No.: 19/568,793

(22) Filed: Mar. 17, 2026

(30) Foreign Application Priority Data
Mar. 19, 2025 (JP) 2025-045820

(51) Int. Cl. H02J 7/54; H01M 10/48; H02J 7/00; H02J 7/50; H02J 7/60; H02J 7/92

(52) U.S. Cl. CPC H02J 7/54; H01M 10/482; H02J 7/585; H02J 7/663; H02J 7/855; H02J 7/92

(57) ABSTRACT

A battery system includes an external output circuit, a main relay, a pre-charge circuit, a plurality of battery module units, and a controller. Each of the plurality of battery module units includes a plurality of battery cells and a unit relay. The controller turns OFF the main relay while keeping the unit relays of the plurality of battery module units ON. The controller turns OFF the unit relays based on at least one of the following conditions: a time during which the unit relays are kept ON has exceeded a predetermined time; and a current value difference between the plurality of battery module units is less than or equal to a predetermined specified value after turning ON the unit relays.

### CROSS REFERENCE TO RELATED APPLICATIONS

The present application claims priority from Japanese Patent Application No. 2025-045820 filed on Mar. 19, 2025, which is incorporated by reference herein in its entirety.

### BACKGROUND

The present disclosure relates to battery systems.

JP 5772708 B discloses a method for connecting an assembled battery that includes equalizing the voltages of battery packs when an ignition is off and connecting the output of the battery packs to a load when the ignition is turned on. Equalizing of the voltages of battery packs is implemented by passing electric current between the battery packs via an inrush current prevention resistor when the voltages of the battery packs are not uniform. When connecting the output of the battery packs to the load, the output of the battery packs is connected to the load through the inrush current prevention resistor. After a predetermined time has elapsed from the connecting, the output of the battery packs is connected to the load not through the inrush current prevention resistor.

### SUMMARY

It is desired to improve the safety of the battery system.

A battery system disclosed herein includes an external output circuit, a main relay, a pre-charge circuit, a plurality of battery module units, and a controller. The external output circuit includes a positive electrode terminal and a negative electrode terminal, each of which is connected to an external load. The main relay is provided in the external output circuit. The pre-charge circuit is connected in parallel to the main relay. The plurality of battery module units are provided so as to be connected to an external load through the main relay. Each of the plurality of battery module units includes a plurality of battery cells and a unit relay. The plurality of battery cells are connected in series. The unit relay is connected in series to the plurality of battery cells. When turning OFF the main relay, the controller turns OFF the main relay while keeping the unit relays of the plurality of battery module units ON. The controller turns OFF the unit relays based on at least one of the following conditions: a time during which the unit relays are kept ON has exceeded a predetermined time; and a current value difference between the plurality of battery module units is less than or equal to a predetermined specified value after turning ON the unit relays. The battery system as described above provides improved safety.

### BRIEF DESCRIPTION OF THE DRAWINGS

FIG. 1 is a schematic view illustrating a battery system 100.

FIG. 2 is a schematic view illustrating equalizers 19 provided in a battery module unit 10a.

FIG. 3 is a flowchart illustrating processing executed in a controller 50.

FIG. 4 is a graph illustrating changes in voltage values of battery module units 10a to 10c.

FIG. 5 is another graph illustrating changes in voltage values of the battery module units 10a to 10c.

FIG. 6 is a flowchart illustrating another processing executed in the controller 50.

FIG. 7 is yet another graph illustrating changes in voltage values of the battery module units 10a to 10c.

### DETAILED DESCRIPTION

Hereinbelow, embodiments of the technology according to the present disclosure will be described with reference to the drawings. It should be noted, however, that the embodiments disclosed herein are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate.

### Battery System 100

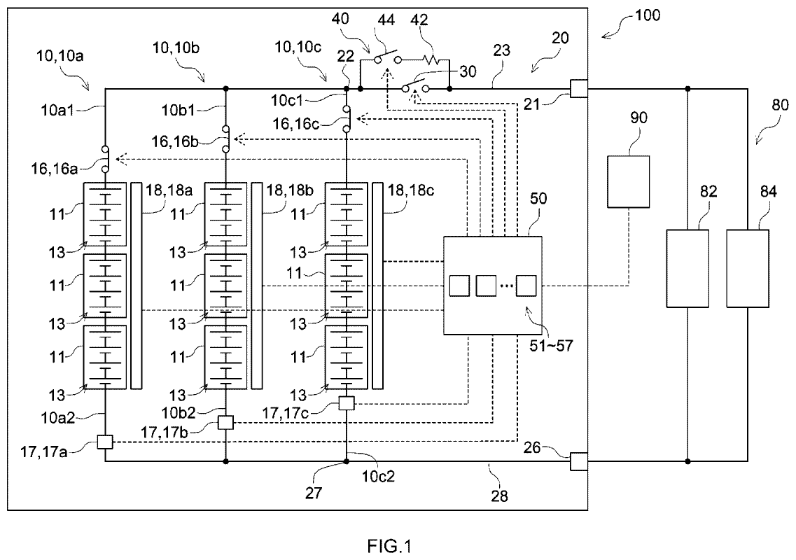

FIG. 1 is a schematic view illustrating a battery system 100. As illustrated in FIG. 1, the battery system 100 includes a plurality of battery module units 10a to 10c, an external output circuit 20, a main relay 30, a pre-charge circuit 40, and a controller 50. The battery system 100 also includes a current sensor 17 and a voltage sensor 18. The battery system 100 is also referred to as a battery pack, which is an assembly including battery modules along with components for controlling the batteries and the like.

In this embodiment, the battery system 100 includes three battery module units 10a to 10c. The number of the battery module units contained in the battery system 100 is not limited to any particular number. The configurations of the battery module units 10a to 10c are identical to each other. Hereinafter, when the description common to the battery module units 10a to 10c is made, each battery module unit is referred to as a battery module unit 10 as appropriate.

### Plurality of Battery Module Units 10a to 10c

The plurality of battery module units 10a to 10c each include a battery module 11 and a unit relay 16 (16a to 16c). In this embodiment, the battery module units 10a to 10c each include a plurality of battery modules 11 connected in series. The battery modules 11 may be a single battery module. The plurality of battery module units 10a to 10c each also include a current sensor 17 (17a to 17c) and a voltage sensor 18 (18a to 18c). The battery modules 11 each include a plurality of battery cells 13 connected in series.

The battery cell 13 may be a secondary battery in which repeated charging and discharging are possible by means of migration of charge carriers through an electrolyte between a pair of electrodes (positive electrode and negative electrode). The battery cell 10 may be a lithium-ion secondary battery, a nickel-metal hydride battery, or the like, for example. The battery cell 13 stores (i.e., is charged by) electric power supplied from a charger 84. The electric power stored in the battery cell 13 is supplied to an external load 82. In this embodiment, the battery module unit 10 includes a plurality of battery cells 13 connected in series. The battery cell 13 may be composed of a single battery or may be composed of a unit including a plurality of batteries connected in parallel. For the battery cells 13 constituting the battery module 11, and for the battery module 11, it is possible to include one or plurality or batteries connected in parallel. In other words, in the battery module 11, the battery cells 13 may be connected in a combination of series and parallel connections. The battery module unit 10 includes a positive electrode and a negative electrode that corresponds to the positive electrode and the negative electrode of the battery cell 13.

Unit relays 16a to 16c are connected to the plurality of battery cells 13 connected in series. The unit relays 16a to 16c are connected to positive electrode-side connecting wires 10a1 to 10c1 of the battery module units 10a to 10c. It is also possible that the unit relays 16a to 16c may be connected to negative electrode-side connecting wires 10a2 to 10c2. The unit relays 16a to 16c are configured to be switchable between ON (closed state) and OFF (open state). The unit relays 16a to 16c may be, but are not particularly limited to, electromechanical relays, semiconductor relays, and the like. When the unit relays 16a to 16c are turned ON, the battery module units 10a to 10c are electrically connected to an external connected device 80. The switching of the unit relays 16a to 16c between ON and OFF is controlled by the controller 50.

Current sensors 17a to 17c are connected to negative electrode-side connecting wires 10a2 to 10c2 of the battery module units 10a to 10c. In other words, the current sensors 17a to 17c are disposed between the negative electrodes of the battery module units 10a to 10c and a negative electrode-side connecting point 27. The current sensors 17a to 17c measure charging/discharging currents flowing through the battery module units 10a to 10c. The current sensors 17a to 17c are each configured to be communicable with the controller 50. The charging/discharging currents measured by the current sensors 17a to 17c are transmitted to the controller 50. The positions of the current sensors 17a to 17c are not particularly limited. It is also possible that the current sensors 17a to 17c may be connected to the positive electrode-side connecting wires 10a1 to 10c1.

The voltage sensors 18a to 18c measure voltage values of the battery module units 10a to 10c. Herein, the voltage value of a battery module unit indicates the total of the voltage values of a plurality of batteries (or a plurality of battery modules) connected in series, which constitute the battery module unit. The voltage sensors 18a to 18c are electrically connected respectively to the plurality of battery module units 10a to 10c. The voltage sensors 18 may be able to measure the voltage of the battery module unit 10, or may be able to measure the voltage of one or a plurality of battery cells 13 that constitute the battery module unit 10. In this embodiment, although not shown in detail in the drawings, the voltage sensors 18 are connected in parallel respectively to the plurality of battery cells 13 and configured to measure the voltage value of each of the battery cells 13. Measured voltage values are transmitted to the controller 50, which will be detailed later, to calculate each of the voltage values of the battery module units 10a to 10c.

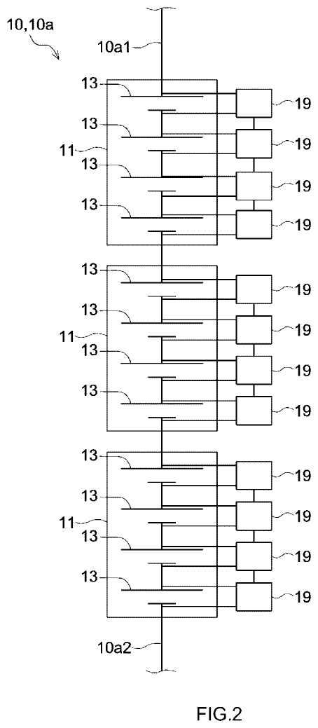

The plurality of battery module units 10a to 10c may include equalizers 19 for equalizing the remaining capacities of the plurality of battery cells 13. FIG. 2 is a schematic view illustrating the equalizers 19 provided in the battery module unit 10a. The equalizers 19 of the battery module units 10b and 10c also have the same configuration as the equalizers 19 of the battery module unit 10b. As illustrated in FIG. 2, the equalizers 19 are provided respectively for the battery cells 13 of the battery module unit 10a. The equalizers 19 are connected in parallel to the battery cells 13. Adjacent equalizers 19 contained in the same battery module 11 are connected to each other. This makes it possible to equalize the remaining capacities of the battery cells 13 within the battery module 11.

The equalizers 19, which are also referred to as equalization circuits, equalize the battery capacities of the battery cells 13 (or battery modules 11) connected in series within the battery module unit 10a. Although not shown in detail in the drawings, each of the equalizers 19 may be composed of a closed circuit in which a resistor and a switch (for example, FET) are connected to a battery cell 13. When the battery cell 13 is connected to the resistor, electric power of the battery cell 13 is consumed, reducing the battery capacity. For example, the battery capacity of a battery cell 13 that has the lowest battery capacity among the battery cells 13 may be set to the target value for the equalization. The opening and closing of the switch of the closed circuit may be controlled by the controller 50 (see FIG. 1) based on the voltage values of the battery cells 13. Note that the configuration of the equalizers 19 is not limited to any particular configuration. The equalizers 19 may have a circuit configuration that performs what is called active balancing, which allows the electric power of battery cells with excess battery capacities among the plurality of battery cells 13 to be shifted to battery cells 13 with lower battery capacities.

As illustrated in FIG. 1, the battery module units 10a to 10c are connected to the connected device 80 via the main relay 30, which will be detailed later. The battery module units 10a to 10c supplies electric power to, or are charged by, the connected device 80. The connected device 80 may include, but is not particularly limited to, an external load 82, a charger 84, and the like. To the external load 82, electric power is supplied from the battery cells 13 in the battery module units 10a to 10c. In this embodiment, the external load 82 is a load of an electrically powered vehicle, which may include electric motors, inverters, and the like of the vehicle. The battery system 100 is not limited to such an embodiment but may be applicable to electricity storage apparatuses other than those incorporated in electrically powered vehicles. The controller 50 is configured to be communicable with an on-board ECU (Electronic Contril Unit) 90, which is incorporated in the vehicle. The charger 84 is a device that is capable of supplying electric power to the battery cells 13. The battery system 100 is connected to the external connected device 80 via the external output circuit 20.

### External Output Circuit 20

The external output circuit 20 includes a positive electrode terminal 21 and a negative electrode terminal 26. The positive electrode terminal 21 and the negative electrode terminal 26 are connected to the connected device 80. This allows the connected device 80 to be connected in series to the battery module units 10a to 10c contained in the battery system 100. The external output circuit 20 includes connecting wires 23 and 28. The connecting wire 23 connects the positive electrode terminal 21 to a positive electrode-side connecting point 22 of the battery module units 10a to 10c. The connecting wire 28 connects the negative electrode terminal 26 to a negative electrode-side connecting point 27 of the battery module units 10a to 10c. The external output circuit 20 is provided with the main relay 30 and the pre-charge circuit 40.

### Main Relay 30

The main relay 30 is provided on the positive electrode-side connecting wire 23 of the external output circuit 20. In other words, the main relay 30 is disposed between the positive electrode terminal 21 and the positive electrode-side connecting point 22 of the battery module units 10a to 10c. It is also possible that the main relay 30 may be provided on the negative electrode-side connecting wire 28. It is also possible that the main relay 30 may be provided on both the positive electrode-side connecting wire 23 and the negative electrode-side connecting wire 28.

The main relay 30 is configured to be switchable between ON (closed state) and OFF (open state). The main relay 30 may be, but is not particularly limited to, an electromechanical relay, a semiconductor relay, and the like. In the battery system 100, when the main relay 30 is turned ON, the battery module unit 10 and the external connected device 80 are electrically connected.

### Pre-Charge Circuit 40

The pre-charge circuit 40 is connected in parallel to the main relay 30. The pre-charge circuit 40 is a circuit that prevents inrush current from flowing into the connected device 80 and the battery module unit 10. The pre-charge circuit 40 is a circuit including a pre-charge resistor 42 and a pre-charge relay 44 that are connected in series. The pre-charge circuit 40 prevents inrush current from flowing when, for example, electric power is supplied from the battery module unit 10 to the external load 82 or when electric power is supplied from the charger 84 to the battery module unit 10. Hereinbelow, controlling of the main relay 30 and the pre-charge relay 44 to turn ON/OFF is described, taking the operation during the start-up of the external load 82 as an example.

Before the external load 82 is started up, the main relay 30 and the pre-charge relay 44 are in the OFF state. When starting up the external load 82, the pre-charge relay 44 is switched to the ON state. This allows the external load 82 to connect to the battery module unit 10 through the pre-charge circuit 40. At this time, because the pre-charge circuit 40 is provided with the pre-charge resistor 42, the external load 82 is supplied with electric power from the battery module unit 10 with a low current. Thereafter, the main relay 30 is turned to the ON state with the potential of the external load 82 being high. Subsequently, the pre-charge relay 44 is turned to the OFF state. This prevents a high current from flowing, for example, when starting up the external load 82.

When the main relay and the unit relays are turned OFF at the time of shutting down of the battery system, the voltage values of the battery module units gradually decrease. According to the knowledge of the present inventors, if the unit relays are turned OFF immediately after the main relay is turned OFF at the time of shutting down of the battery system, the time periods required for stabilizing the voltage values of the units may vary. In other words, among the plurality of battery module units, some units may allow the voltage values to stabilize quickly while other units may allow the voltage values to stabilize more slowly. If the voltage values do not converge in some of the units when the unit relays are turned ON, such as when starting up the external load again, there is a risk that an inrush current occurs depending on the difference in voltage values between the units.

The switching of the main relay 30 and the pre-charge relay 44 between ON and OFF is controlled by the controller 50.

### Controller 50

The controller 50, which is also referred to as the BCU (Battery Control Unit), controls the battery module units 10a to 10c contained in the battery system 100. The controller 50 may be a computer, such as an ECU (electronic control unit) or a circuit board with a built-in microcomputer, for example. The computer performs required functions according to, for example, a predetermined program. Various functions of the computer may be processed by cooperation of software with an arithmetic unit [also referred to as a processor, CPU (central processing unit), or MPU (micro-processing unit)] and a memory storage device (such as a memory and a hard disk) of the computer.

The controller 50 includes a communicator 51, a first instructor 52, a second instructor 53, a third instructor 54, a first determinator 55, a second determinator 56, and a third determinator 57. Each of these units 51 to 57 of the controller 50 may be implemented by a single processor or a plurality of processors, or may be incorporated in a circuit. The communicator 51 of the controller 50 is configured to be communicable with the current sensor 17 and the voltage sensor 18. Communication of the controller 50 with the current sensor 17 and the voltage sensor 18 may be achieved by the transmission and reception of signals. The form of communication of the controller 50 with the voltage sensor 18 and the current sensor 17 is not limited to any particular form. The controller 50 switches the ON and OFF states of the main relay 30 and the pre-charge relay 44 according to a predetermined condition.

Hereinbelow, an example of the processing executed by the controller 50 during charging and discharging of the battery system 100 is described. The following describes processing that is executed by the controller 50 after an ignition switch (not shown) of a vehicle is turned from ON to OFF. Whie the ignition switch is the ON state, the main relay 30 and the unit relays 16a to 16c are kept ON. After charging and discharging of the vehicle, the ignition switch is turned from ON to OFF, and then, the control operation by the controller 50 is started.

### First Embodiment

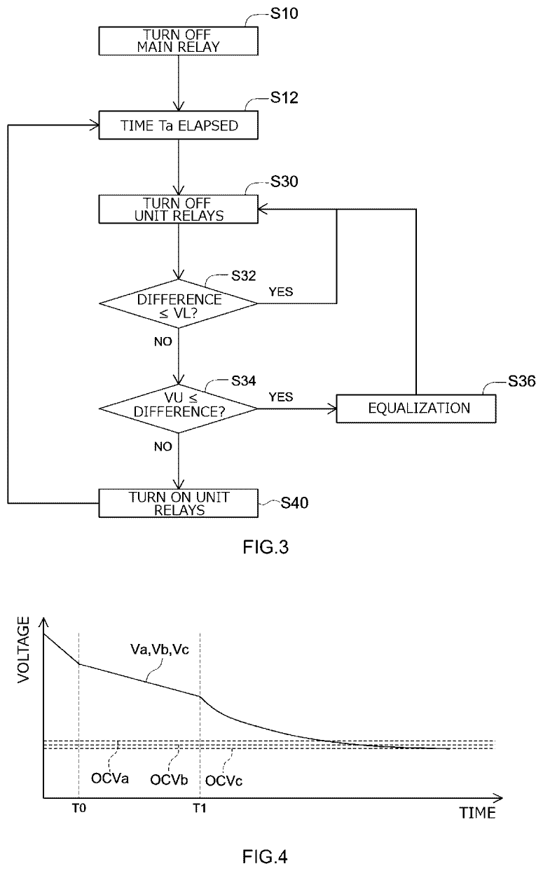

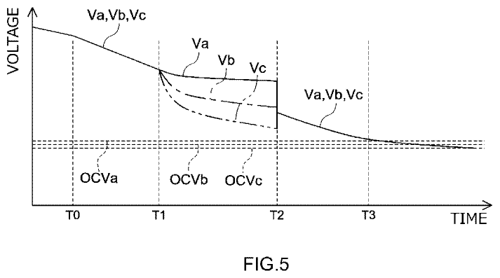

FIG. 3 is a flowchart illustrating processing executed by the controller 50. FIG. 4 is a graph illustrating changes in the voltage values of the battery module units 10a to 10c. FIG. 4 shows changes in the voltage values during the processing by the controller 50. In step S10 (see FIG. 3), the first instructor 52 turns OFF the main relay 30 at time point T0 (see FIGS. 4 and 5). This allows the battery module units 10a to 10c and the connected device 80 to be disconnected. When the main relay 30 is turned OFF, the voltage values of the battery module units 10a to 10c gradually decrease. At this time, the unit relays 16a to 16c of the plurality of battery module units 10a to 10c are kept in the ON state. Because the battery module units 10a to 10c are connected to each other, the voltage values of the battery module units 10a to 10c may gradually decrease in a substantially similar manner (see FIG. 4).

In step S12 (see FIG. 3), the unit relays 16a to 16c are kept in the ON state until a predetermined time (prescribed time) Ta elapses after the main relay 30 is turned OFF. In this embodiment, the unit relays 16a to 16c are kept in the ON state to time point T1 (see FIG. 4), which is after time Ta has elapsed since time point T0.

In step S30 (see FIG. 3), the second instructor 53 turns OFF the unit relays 16a to 16c. The unit relays 16a to 16c are switched OFF based on the time for which the unit relays 16a to 16c have been kept ON. In this embodiment, the unit relays 16a to 16c are turned OFF at time point T1, at which the predetermined time Ta has elapsed since time point T0.

Once the unit relays 16a to 16c are turned OFF, the voltage values of the battery module units 10a to 10c decrease more quickly in comparison with the time period before time point T1.

In step S32 (see FIG. 3), the first determinator 55 determines whether or not the difference between the voltage values of the battery module units 10a to 10c is less than or equal to a lower limit threshold value VL. The voltage difference is determined based on the voltage values that are measured by the voltage sensors 18a to 18c and transmitted to the communicator 51. Note that the difference here is the difference between the maximum voltage value and the minimum voltage value of the voltage values of the battery module units 10a to 10c that are measured by the voltage sensors 18a to 18c.

If the difference is less than or equal to the lower limit threshold value (YES), the process returns to step S30, and the unit relays 16a to 16c are kept in the OFF state. At this time, it is determined that each of the voltage values of the battery module units 10a to 10c converges to the open circuit voltage OCV, so the OFF state of the unit relays 16a to 16c is maintained. The OCVs of the battery module units 10a to 10c may vary from each other. In FIG. 4, the OCVs of the battery module units 10a to 10c are respectively represented as OCVa to OCVc. It is possible that the lower limit threshold value VL may be set to the OCV of each of the units. The respective voltage values of the battery module units 10a to 10c converge to their OCVs, so the external load 82 can be shut down safely after turning OFF the ignition switch of the vehicle.

In the embodiment described above, the battery system 100 includes the external output circuit 20, the main relay 30, the pre-charge circuit 40, the plurality of battery module units 10a to 10c, and the controller 50. The external output circuit 20 includes the positive electrode terminal 21 and the negative electrode terminal 26, which are connected to the external load 82. The main relay 30 is provided in the external output circuit 20. The pre-charge circuit 40 is connected in parallel to the main relay 30. The plurality of battery module units 10a to 10c are connected to the external load 82 through the main relay 30. The plurality of battery module units 10a to 10c each include the plurality of battery cells 13 and the respective unit relays 16a to 16c. The plurality of battery cells 13 are connected in series to each other. The unit relays 16a to 16c are connected in series to the plurality of battery cells 13. The controller 50 turns OFF the main relay 30 while the unit relays 16a to 16c of the plurality of battery module units 10a to 10c are being kept ON. The controller 50 turns OFF the unit relays 16a to 16c based on the fact that the time during which the unit relays 16a to 16c have been kept ON has exceeded a predetermined time Ta.

In such a battery system 100, the main relay 30 is turned OFF while the unit relays 16a to 16c of the plurality of battery module units 10a to 10c are kept ON (step S10). This reduces the difference in voltage values between the plurality of battery module units 10a to 10c. Moreover, the unit relays 16a to 16c are kept ON during the predetermined time Ta (step S12), and thereafter, the unit relays 16a to 16c are turned OFF (step S30). This reduces the difference in voltage values between the plurality of battery module units 10a to 10c. As a result, the difference in the voltage values between the units is easily made smaller when the unit relays are turned ON, such as when the external load is started up again. Therefore, an inrush current is easily prevented from occurring.

In the first embodiment described above, when the unit relays 16a to 16c are switched to the OFF state, the voltage values of the battery module units 10a to 10c decrease approximately to the same level (see FIG. 4). However, when the battery module units 10a to 10c are not connected to each other, the voltage values of the battery module units 10a to 10c may decrease to varying levels.

### Second Embodiment

FIG. 5 is a graph illustrating changes in the voltage values of the battery module units 10a to 10c. In FIG. 5, the change of the voltage value of the battery module unit 10a is represented by a solid line, the change of the voltage value of the battery module unit 10b is represented by a dot-dashed line, and the change of the voltage value of the battery module unit 10c is represented by a dash-dot-dot line. In the embodiment shown in FIG. 5, the degree of voltage value drop varies between the battery module units 10a to 10c after the unit relays 16a to 16c are turned OFF (step S30). Herein, the degree of voltage value drop is greater in the following order: voltage Vc of the battery module unit 10c, voltage Vb of the battery module unit 10b, and voltage Va of the battery module unit 10a. This means that the difference between the voltages Va to Vc of the battery module units 10a to 10c may increase over time.

The processes from step S10 to step S30 in the second embodiment are the same as those in the first embodiment and therefore not further described in detail. In step S32, if the difference is greater than the lower limit threshold value VL (NO), the process proceeds to step S34.

In step S34 (see FIG. 3), the second determinator 56 determines whether or not the difference between the voltage values of the battery module units 10a to 10c is greater than or equal to an upper limit threshold value VU. Herein, the upper limit threshold value VU is greater than the previously-mentioned lower limit threshold value VL. In step S34, if the difference is less than the upper limit threshold value VU (NO), the process proceeds to step S40.

In step S40 (see FIG. 3), the second instructor 53 turns ON the unit relays 16a to 16c. In this embodiment, the unit relays 16a to 16c are turned ON at time point T2 (see FIG. 5). When the unit relays 16a to 16c are turned ON, electric current flows from a unit with a higher voltage value to a unit with a lower voltage value. In this embodiment, electric current flows from the battery module unit 10a, which has the highest voltage value, and the battery module unit 10b, which has the second highest voltage value, to the battery module unit 10c, which has the lowest voltage value. As a result, the voltage values of the battery module units 10a to 10c become substantially the same.

After the unit relays 16a to 16c are turned ON in step 40, the voltage values of the battery module units 10a to 10c gradually decrease (see FIG. 5). Here, because the battery module units 10a to 10c are connected to each other, the voltage values of the battery module units 10a to 10c may gradually decrease in a substantially similar manner.

The process returns to step S12, and the unit relays 16a to 16c are kept in the ON state until a predetermined time (prescribed time) Ta elapses. In this embodiment, the unit relays 16a to 16c are kept in the ON state to time point T3 (see FIG. 5), which is after time Ta has elapsed since time point T2.

In step S30, the second instructor 53 turns OFF the unit relays 16a to 16c. In this embodiment, the unit relays 16a to 16c are turned OFF after the predetermined time Ta has elapsed (at time point T3). As a result, the unit relays 16a to 16c are switched OFF based on the time for which the unit relays 16a to 16c have been kept ON.

In step S32, if the difference is less than or equal to the lower limit threshold value (YES), the process returns to step S30, and the unit relays 16a to 16c are kept in the OFF state. The respective voltage values of the battery module units 10a to 10c converge to their OCVs, so the external load 82 can be shut down safely after turning OFF the ignition switch of the vehicle.

According to the knowledge of the present inventors, when the voltage difference between the battery module units is great, the time required for the voltage values of the battery module units to converge to the OCV after turning ON the unit relays varies greatly. The smaller the difference, the less the variation in the time required for the voltage values of the units to converge to the OCV. When there are some units in which their voltage values have not yet converge to the OCV, there is a risk that an inrush current may occur between the units when, for example, the external load is started up again.

In the embodiment described above, after turning OFF the unit relays 16a to 16c, the controller 50 turns ON the unit relays 16a to 16c when the difference between the maximum voltage value and the minimum voltage value that are measured by the voltage sensor 18 is less than the upper limit threshold value VU. This allows the unit relays 16a to 16c to be turned ON under the condition in which the voltage difference between the units is small. At this time, because the voltage difference between the units is small, it is possible to prevent an inrush current from occurring in the closed circuit constructed by the battery module units 10a to 10c. It should be noted that the upper limit threshold value VU may be predetermined from, for example, the configuration of the battery module units 10a to 10c, the electric current that may result from the potential difference between the units, the withstanding voltage of the units, and the like.

In the embodiment described above, after turning OFF the unit relays 16a to 16c in step S30, the controller 50 controls the unit relays 16a to 16c to be turned ON in step S40 if the difference is greater than a predetermined lower limit threshold value VL (NO). It should be noted that in the present description, the upper limit threshold value VU is also referred to as the first threshold value, and the lower limit threshold value VL is also referred to as the second threshold value. By turning ON the unit relays 16a to 16c when the difference (the voltage difference between the battery module units 10a to 10c) is greater than the second threshold value (lower limit threshold value VL), the voltage values of the battery module units 10a to 10c may be lowered more quickly. As a result, power consumption may be reduced at the time of shutting down the external load 82.

In the embodiment described above, the unit relays 16a to 16c are switched ON/OFF simultaneously in step S40. However, the unit relays 16a to 16c may not necessarily be switched simultaneously. The second instructor 53 may turn ON the unit relays 16a to 16c of the battery module units 10a to 10c in descending order of the voltage values of the battery module units 10a to 10c that are measured by the voltage sensors 18a to 18c. This reduces the time required for each of the voltage values of the battery module units 10a to 10c to converge to the OCV when the difference in the voltage values is relatively small.

In the embodiment described above, in step S34, the determination is made that the difference is less than the upper limit threshold value VU (NO). In step S34, if it is determined that the difference is greater than or equal to the upper limit threshold value VU (YES), the process proceeds to step S36.

In step S36, the third instructor 54 instructs the equalizers 19 to perform equalization of the battery cells 13 contained in the battery module units 10a to 10c. The equalizers 19 equalize the remaining capacities of the plurality of battery cells 13. Such equalization of the remaining capacities is performed under the condition in which the unit relays 16a to 16c are OFF. This reduces the variation between the voltage values of the battery cells 13 contained in the respective units. As a result, the voltage values of the respective units are allowed to converge to their OCVs while preventing an inrush current between the units.

In the first and second embodiments described above, the timing for the unit relays 16 to be turned OFF is determined based on the time for which the unit relays 16 are kept ON. However, the timing for the unit relays 16 to be switched ON/OFF is not limited to the embodiments described above.

### Third Embodiment

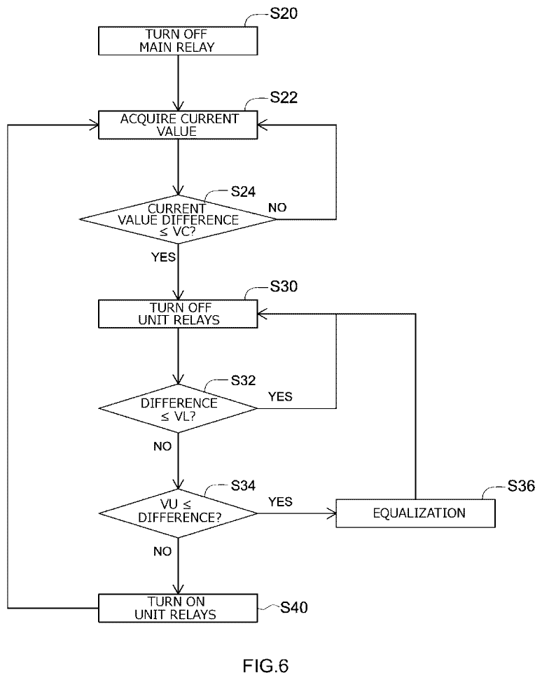

FIG. 6 is a flowchart illustrating processing executed by the controller 50. FIG. 6 illustrates processing in the third embodiment that is executed by the controller 50 after the ignition switch of the vehicle is turned from ON to OFF.

In step S20 (see FIG. 6), the first instructor 52 transmits a signal to the main relay 30 to turn OFF the main relay 30, as in the first and second embodiments. This allows the battery module units 10a to 10c and the connected device 80 to be disconnected. When the main relay 30 is turned OFF, the voltage values of the battery module units 10a to 10c gradually decrease. As in the first and second embodiments, the unit relays 16a to 16c of the plurality of battery module units 10a to 10c are kept in the ON state. Because the battery module units 10a to 10c are connected to each other, the voltage values of the battery module units 10a to 10c may gradually decrease in a substantially similar manner (see FIG. 5).

In step S22 (see FIG. 6), the current values of the battery module units 10a to 10c that are measured by the current sensors 17a to 17c are acquired.

In step S24 (see FIG. 6), the third determinator 57 determines whether or not the difference between the current values of the battery module units 10a to 10c is less than or equal to a predetermined threshold value VC (third threshold value). The difference in the current values is determined based on the current values that are measured by the current sensors 17a to 17c and transmitted to the communicator 51. Note that the difference in the current values here is the difference between the maximum current value and the minimum current value of the current values of the battery module units 10a to 10c that are measured by the current sensors 17a to 17c. The threshold value VC may be predetermined from, for example, the configuration of the battery module units 10a to 10c, the electric current that may result from the potential difference between the units, the withstanding voltage of the units, and the like.

If the difference in the current values is greater than the threshold value VC (NO), the process returns to step S22, and the determination based on the current values continues. If the difference in the current values is less than or equal to the threshold value VC, the process proceeds to step S30. In step S30 (see FIG. 6), the second instructor 53 turns OFF the unit relays 16a to 16c. Except for the processes after step S40, the processes after step S30 are the same as those in the first and second embodiments and therefore not further described in detail. In step S40 (see FIG. 6), the second instructor 53 turns ON the unit relays 16a to 16c. Thereafter, the process returns to step S22, and the current values are acquired again.

As described above, the timing for turning OFF the unit relays 16a to 16c may be determined based on the time during which the unit relays 16a to 16c have been ON (the first and second embodiments), or may be determined based on the difference between the current values of the plurality of battery module units 10a to 10c after turning ON the unit relays 16a to 16c (the third embodiment). When the timing for turning OFF the unit relays 16a to 16c is determined based on time, the processing executed by the controller 50 may be made simpler. When the timing for turning OFF the unit relays 16a to 16c is determined based on the current values, it may be possible to turn OFF the unit relays 16a to 16c at more appropriate timing and to shut down the system more quickly. In addition, the timing for turning OFF the unit relays 16a to 16c may be determined in combinations of the condition determined based on the above-described time and the condition determined based on the difference in the current values between the units. For example, it is possible that the unit relays 16a to 16c may be turned ON when either of the following conditions, the condition determined based on the above-described time or the condition determined based on the difference in the current values between the units, is satisfied.

In the first to third embodiments described above, all the unit relays 16a to 16c are switched ON in step S40. However, it is not necessarily required that all the unit relays 16a to 16c be switched ON. It is also possible that some of the unit relays 16a to 16c may be switched ON.

### Fourth Embodiment

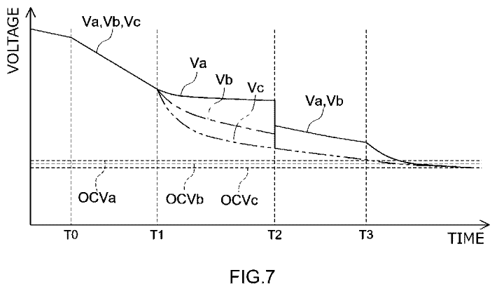

In a fourth embodiment, the processes other than step S40 (see FIGS. 3 and 6) are the same as those described in the second and third embodiments and therefore not further described in detail. FIG. 7 is a graph illustrating changes in the voltage values of the battery module units 10a to 10c. FIG. 7 shows the voltage values of the battery module units 10a to 10c that change due to the processing of the fourth embodiment.

In this embodiment, as illustrated in FIG. 7, the voltage values of the battery module units 10a to 10c at time point T2 increase in the following order: voltage Vc of the battery module unit 10c, voltage Vb of the battery module unit 10b, and voltage Va of the battery module unit 10a. In step S40 of the fourth embodiment, the second instructor 53 turns ON the unit relay 16a and the unit relay 16b. The unit relay 16c is not turned ON. When the unit relays 16a and 16b are turned ON, electric current flows from the battery module unit 10a to the battery module unit 10b. This reduces the voltage difference between the battery module unit 10a and the battery module unit 10b. By controlling electric current to flow between the units that have a relatively small difference in voltage values, the difference in voltage values can be adjusted more easily while preventing an inrush current is prevented from occurring between the units.

The third determinator 57 determines whether or not the difference between the voltage Va of the battery module unit 10a and the voltage Vb of the battery module unit 10b is less than the third threshold value. The second instructor 53 may turn ON the unit relays 16a and 16b when the difference is less than the third threshold value. The third threshold value may be predetermined from, for example, the configuration of the battery module units 10a to 10c, the electric current that may result from the potential difference between the units, the withstanding voltage of the units, and the like. Such a configuration makes an inrush current less likely to occur between the units.

Thereafter, until the difference between the voltage values of the battery module units 10a to 10c becomes less than or equal to the lower limit threshold value VL, the process of turning ON the unit relays of the two units having higher voltage values may be repeated to reduce the voltage difference between the units.

In the present application, one of the battery module units that has the highest voltage value as measured by the voltage sensors 18 is also referred to as a first voltage unit, one that has a voltage value less than the voltage value of the first voltage unit as measured by the voltage sensors 18 is also referred to as a second voltage unit, and one that has a voltage value less than the voltage value of the second voltage unit as measured by the voltage sensors 18 is also referred to as a third voltage unit. In this embodiment, the battery module unit 10a corresponds to the first voltage unit, the battery module unit 10b corresponds to the second voltage unit, and the battery module unit 10c corresponds to the third voltage unit.

In the above-described embodiment, no resistor is connected in series to the battery modules 11 in the battery module units 10a to 10c. No resistor is connected in parallel to the battery modules 11 in the battery module units 10a to 10c. Because the battery modules 11 do not contain a resistor that is connected in series or in parallel thereto, the power consumption in the battery module units 10a to 10c may be reduced.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1

A Battery System Including:
an external output circuit including a positive electrode terminal and a negative electrode terminal, each connected to an external load;
a main relay provided in the external output circuit;
a pre-charge circuit connected in parallel to the main relay;
a plurality of battery module units provided so as to be connected to the external load through the main relay; and
a controller, wherein:
each of the plurality of battery module units includes:
   a plurality of battery cells connected in series; and
   a unit relay connected in series to the plurality of battery cells; and
the controller turns OFF the main relay while keeping the unit relays of the plurality of battery module units ON; and
the controller turns OFF the unit relays based on at least one of the following conditions: a time during which the unit relays are kept ON has exceeded a predetermined time; and a current value difference between the plurality of battery module units is less than or equal to a predetermined specified value after turning ON the unit relays.

### Item 2

The battery system according to item 1, further including:
a voltage sensor being electrically connected to each of the plurality of battery module units and measuring voltage values of the battery module units; and wherein
after turning OFF the unit relays, the controller turns ON the unit relays when a difference between a maximum voltage value and a minimum voltage value that are measured by the voltage sensor is less than a predetermined first threshold value.

### Item 3

The battery system according to item 2, wherein:
the plurality of battery module units includes an equalizer equalizing remaining capacities of the plurality of battery cells; and
the controller causes the equalizer to equalize the remaining capacities of the plurality of battery cells when the difference is greater than or equal to the first threshold value after turning OFF the unit relays.

### Item 4

The battery system according to item 2 or 3, wherein the controller turns ON the unit relays of the battery module units in descending order of voltage values of the battery module units that are measured by the voltage sensor when the difference is greater than or equal to the first threshold value after turning OFF the unit relays.

### Item 5

The battery system according to any one of items 2 to 4, wherein:
the controller turns ON the unit relays when the difference is greater than a predetermined second threshold value after turning OFF the unit relays; and
the second threshold value is less than the first threshold value.

### Item 6:

The battery system according to any one of items 1 to 5, wherein:
the plurality of battery module units comprise at least three battery module units;
the battery system further comprises a voltage sensor being electrically connected to each of the plurality of battery module units and measuring voltage values of the battery module units; and
after turning OFF the unit relays, the controller turns ON the unit relay of a first voltage unit and the unit relay of a second voltage unit, where, of the plurality of battery module units, the first voltage unit is one having a highest voltage value measured by the voltage sensor, the second voltage unit is one having a voltage value less than the voltage value of the first voltage unit, and a third voltage unit is one having a voltage sensor less than the voltage sensor of the second voltage unit.

### Item 7

The battery system according to item 6, wherein the controller turns ON the unit relay connected to the first voltage unit and the unit relay connected to the second voltage unit when a difference between the voltage value of the first voltage unit and the voltage value of the second voltage unit is less than a predetermined third threshold value.

What is claimed is:

1. A battery system comprising:
an external output circuit including a positive electrode terminal and a negative electrode terminal, each connected to an external load;
a main relay provided in the external output circuit;
a pre-charge circuit connected in parallel to the main relay;
a plurality of battery module units provided so as to be connected to the external load through the main relay; and
a controller, wherein:
each of the plurality of battery module units includes:
a plurality of battery cells connected in series; and
a unit relay connected in series to the plurality of battery cells; and
the controller turns OFF the main relay while keeping the unit relays of the plurality of battery module units ON; and
the controller turns OFF the unit relays based on at least one of the following conditions: a time during which the unit relays are kept ON has exceeded a predetermined time; and a current value difference between the plurality of battery module units is less than or equal to a predetermined specified value after turning ON the unit relays.

2. The battery system according to claim 1, further comprising:
a voltage sensor being electrically connected to each of the plurality of battery module units and measuring voltage values of the battery module units; and wherein
after turning OFF the unit relays, the controller turns ON the unit relays when a difference between a maximum voltage value and a minimum voltage value that are measured by the voltage sensor is less than a predetermined first threshold value.

3. The battery system according to claim 2, wherein:
the plurality of battery module units includes an equalizer equalizing remaining capacities of the plurality of battery cells; and
the controller causes the equalizer to equalize the remaining capacities of the plurality of battery cells when the difference is greater than or equal to the first threshold value after turning OFF the unit relays.

4. The battery system according to claim 2, wherein the controller turns ON the unit relays of the battery module units in descending order of voltage values of the battery module units that are measured by the voltage sensor when the difference is greater than or equal to the first threshold value after turning OFF the unit relays.

5. The battery system according to claim 2, wherein:
the controller turns ON the unit relays when the difference is greater than a predetermined second threshold value after turning OFF the unit relays; and
the second threshold value is less than the first threshold value.

6. The battery system according to claim 1, wherein:
the plurality of battery module units comprise at least three battery module units;
the battery system further comprises a voltage sensor being electrically connected to each of the plurality of battery module units and measuring voltage values of the battery module units; and
after turning OFF the unit relays, the controller turns ON the unit relay of a first voltage unit and the unit relay of a second voltage unit, where, of the plurality of battery module units, the first voltage unit is one having a highest voltage value measured by the voltage sensor, the second voltage unit is one having a voltage value less than the voltage value of the first voltage unit, and a third voltage unit is one having a voltage sensor less than the voltage sensor of the second voltage unit.

7. The battery system according to claim 6, wherein the controller turns ON the unit relay connected to the first voltage unit and the unit relay connected to the second voltage unit when a difference between the voltage value of the first voltage unit and the voltage value of the second voltage unit is less than a predetermined third threshold value.
